(19) United States
(12) Patent Application Publication
(10) Pub. No.: US 2024/0428239 A1
(43) Pub. Date: Dec. 26, 2024

(54) SYSTEM, DEVICE AND METHOD FOR DIGITAL PAYMENT

(71) Applicant: NAYAX LTD., Herzliya (IL)

(72) Inventors: David BEN-AVI, Herzliya (IL); Guy ROSENHOIZ, Herzliya (IL)

(21) Appl. No.: 18/293,915

(22) PCT Filed: Jul. 13, 2022
(86) PCT No.: PCT/IL2022/050755

§ 371 Date: Jan. 31, 2024

(30) Foreign Application Priority Data
Sep. 5, 2021 (IL) 286171

(51) Int. Cl. G06Q 20/38; G06Q 20/10; G06Q 20/20; G06Q 20/34; G06Q 20/40

(52) U.S. Cl. CPC G06Q 20/387; G06Q 20/10; G06Q 20/20; G06Q 20/348; G06Q 20/351; G06Q 20/382; G06Q 20/401

(57) ABSTRACT

A system and a method for executing payments over a digital network are provided. The system includes a first server operably coupled to a database configured to allocate a disposable payment element to a member of a loyalty club at a second server. The first server is configured to receive a request from a payment service provider (PSP) to approve an amount paid with the disposable payment element at a point of sale (POS), approve the amount to purchase made with the disposable payment element, receive a message from the PSP that a purchase made at the POS is completed, delete the disposable payment element from the payment element database, and upload a new disposable payment element to the payment elements database.

### TECHNICAL FIELD

Some embodiments described herein generally relate to a payment system and method, more specifically to digital payments over a digital network.

### BACKGROUND

A digital payment system may enable to make purchases in virtual stores over the Internet. Those systems may use the user's credit card or other payment methods such as, for example, Pay Pal, crypto coins, or the like to pay for the merchandise.

However, members of loyalty clubs can purchase goods only with their loyalty club points, coupons, and the like and only on stores available for loyalty club members. Stores which they can use their loyalty club card.

### SUMMARY

Embodiments related to a system, a method, and a product for purchasing goods and services are described hereinbelow by the ways of example only.

One embodiment may include A system for executing payments over a digital network comprising: a first server comprises processing circuitry, wherein the first server is operably coupled to a second server comprises a database which comprises a plurality of payment elements of a plurality of loyalty club members, the processing circuitry is configured to: allocate a disposable payment element to a member of the loyalty club from the plurality of payment elements; receive a request message from a payment service provider (PSP) to approve a paid amount which paid with an aid of the disposable payment element at a point of sale (POS); send an approval message to approve the paid amount; receive a confirmation message from the PSP that a payment made at the POS is received; delete the disposable payment element from the plurality of payment elements after receiving the confirmation message, and upload a new disposable payment element to the plurality of payment elements at the database.

For example, the processing circuitry is configured to approve the payment by examining payment details against one or more sets of rules, wherein the set of rules comprises an exchange rate of a benefit of the member of the loyalty club to a currency.

For example, the one or more sets of rules comprises a loyalty club set of rules and the loyalty club set of rules comprises an exchange rate of a loyalty club benefit to currency.

For example, the one or more sets of rules comprises a payment card issuer set of rules, wherein a PSP set of rules comprises a value check of the benefit against the payment.

For example, the processing circuitry is configured to transfer an amount of money paid by the first server for purchases made by members of the loyalty club to the PSP at a predetermined date.

For example, the POS enables purchasing of the loyalty club member according to a purchasing agreement with the PSP, wherein the purchasing agreement comprises one or more purchase terms.

For example, the database is allocated within the second server and operably coupled to the first server.

For example, the database is allocated within the first server and operably coupled to the second server.

For example, a purchasing application is configured to convert a coupon of the loyalty club to an amount of money is used to pay at the POS by using the disposable payment element.

For example, a purchasing application is configured to convert a reward of the loyalty club to an amount of money is used to pay at the POS by using the disposable payment element.

For example, a purchasing application is configured to convert a benefit of loyalty club to an amount of money is used to pay at the POS by using the disposable payment element.

For example, the disposable payment element comprises data of a disposable virtual payment card having a disposable identification code.

For example, a content of the payment element is encrypted and the POS is configured to decrypt the content of the payment element, wherein the POS comprises an at least one of a cashier machine, a physical payment terminal and a virtual payment terminal.

For example, a content of the payment element is encrypted and the POS is configured to transfer the decrypted content of the payment element to PSP, wherein the POS comprises an at least one of a cashier machine, a physical payment terminal and a virtual payment terminal.

For example, the payment element comprises at least one of a debit card number, a debit card issue date and a debit card security code.

For example, the payment element comprises at least one of a credit card number, a credit card issue date and a credit card security code.

For example, the payment element comprises at least one of a prepaid card number, a prepaid card issue date and a prepaid card security code.

For example, the payment element comprises at least one of a loadable card number, a loadable card issue date and a loadable card security code.

For example, the first server comprises a payment manager server.

For example, the second server comprises a loyalty club server.

One other embodiment may includes a product comprising one or more tangible computer-readable non-transitory storage media comprising program instructions for making payments with a payment manager program, wherein execution of the program instructions of the payment manager program by processing circuitry comprising: receiving a request from a payment service provider (PSP) to approve an amount paid with an aid of the disposable payment element at a point of sale (POS); sending an approved message to approve the paid amount; receiving a confirmation message from the PSP that a purchase made at the POS is received; deleting the disposable payment element from the plurality of payment elements at the database; and uploading a new disposable payment element to the plurality of payment elements at the database.

For example, the execution of the program instructions by the processing circuitry may result in approving the purchase by examining the purchase details against one or more sets of rules.

For example, the one or more sets of rules comprises a loyalty club set of rules.

The product of claim 22, wherein the one or more sets of rules comprises a PSP set of rules.

For example, the execution of the program instructions by the processing circuitry may result in transferring an amount of money paid by the payment manager server for purchases made by members of the business group of members to the PSP at a predetermined date.

For example, the POS is configured to enable purchasing of the loyalty club member according to a purchasing agreement with the PSP, wherein the purchasing agreement comprises one or more purchase terms.

For example, a purchasing application is configured to convert a coupon of the loyalty club to an amount of money is used to pay at the POS by using the disposable payment element.

For example, the purchasing application is configured to convert a reward of the loyalty club to an amount of money is used to pay at the POS by using the disposable payment element.

For example, the purchasing application is configured to convert a benefit of the loyalty club to an amount of money is used to pay at the POS by using the disposable payment element.

For example, the disposable payment element comprises data of a disposable virtual payment card having a disposable identification code.

For example, a content of the payment element is encrypted and the POS is configured to decrypt the content of the payment element, wherein the POS comprises an at least one of a cashier machine, a physical payment terminal and a virtual payment terminal.

For example, a content of the payment element is encrypted and the POS is configured to transfer the decrypted content of the payment element to PSP, wherein the POS comprises an at least one of a cashier machine, a physical payment terminal and a virtual payment terminal.

For example, the payment element comprises at least one of a debit card number, a debit card issue date and a debit card security code.

For example, the payment element comprises at least one of a credit card number, a credit card issue date and a credit card security code.

For example, the payment element comprises at least one of a prepaid card number, a prepaid card issue date and a prepaid card security code.

For example, the payment element comprises at least one of a loadable card number, a loadable card issue date and a loadable card security code.

One other embodiment may include a system for executing payments over a digital network comprising: a server comprises: a users database that includes at least one group of members; a payment element database that includes one or more disposable payment elements and configured to allocate a disposable payment element to a member of the group of members; and processing circuitry configured to: receive a request to provide the disposable payment element with the member details to perform a purchase from a point of sale (POS); send a request to check the member credit balance to the group server; convert the member credit to money and upload the money to the disposable payment element; receive a message that the purchase is completed and delete the disposable payment element from the database, and upload a new disposable payment element to the database.

For example, the server is configured to manage a payment process by allocating a disposable payment element for a member of the group for paying over the network.

It is understood from the present disclosure described a solution for shortcomings in the field of art. More specifically, the embodiments described herein enable performing payments by members of the loyalty club by using a disposable payment element.

### BRIEF DESCRIPTION OF THE DRAWING

FIG. 1 illustrates a block diagram of a system for performing payments over a network according to some demonstrative embodiments.

FIG. 2 illustrates a flow chart of a method for purchasing goods using a digital wallet application, according to some other demonstrative embodiments.

FIG. 3 illustrates a block diagram of a system for performing payments over a network according to some other demonstrative embodiments.

FIG. 4 illustrates a flow chart of a method for purchasing goods using a digital wallet application, according to some other demonstrative embodiments.

FIG. 5 illustrates a product of manufacture, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to one or more processors, e.g., as necessary to execute the logic.

The term “module,” as used hereinbelow, is an object file that contains code to extend the running kernel environment.

As used herein, the term “software engine” as used hereinbelow is an object file that contains code to extend the running kernel environment.

The term “loyalty club customer” as used hereinbelow is a business to business (B2B) customer who has a loyalty club offering and operates a loyalty-based mobile service, e.g., loyalty card application for his customer base.

The term “Backend Platform” as used hereinbelow is a cloud platform, backend server, of the digital wallet system, which is configured to manage and control the digital wallet services, and to interact with selected third-party systems, and with the digital wallet module and/or digital wallet engine and/or digital wallet software development kit (SDK).

The term “EMV,” as used hereinbelow, is a payment method based upon a technical standard for smart payment cards and for payment terminals and automated teller machines. EMV originally stood for “Europay, Mastercard, and Visa,” the three companies which created the global payment standard.

The term “EMV terminal,” as used hereinbelow, is a payment terminal also known as a Point of Sale (POS) terminal, credit card terminal, etc. The EMV terminal is a device that interfaces with payment cards, e.g., Europay, Mastercard, Visa, to make electronic funds transfers. The terminal typically consists of a secure keypad for entering a PIN, a screen, a means of capturing information from payments cards, and a network connection to access the payment network for authorization.

In some demonstrative embodiments, the payment terminal may allow a merchant to capture required credit and/or debit card information and transmit this data to the merchant services provider and/or bank for authorization and transfer funds to the merchant. The terminal may allow the merchant and/or their client to swipe, insert and/or hold a card near the device to capture the information.

The term “Issuer NFC-EMV SDK,” as used hereinbelow, may include, for example, an SDK issued and governed by the Issuers. For example, such SDK may be supported by a single Issuer which, when integrated into a mobile application, allows for the communication of a Payment element to an EMV terminal through an NFC protocol.

The term “Server-Side SDK” as used hereinbelow, is the front-end digital wallet software program. In some demonstrative embodiments, this program may reside and be integrated within a customer platform and may manage the front-end payment interaction of the end-user through the connection between the customer platform and the Customer mobile application. For example, the transaction may be managed by the customer platform against a vendor POS that the Customer Platform may be connected to.

The term “customer relationship manager (CRM) application programming interface (API),” as used hereinbelow, is an API configured to communicate with a customer CRM. The customer CRM is configured to manage one or more customer rewards programs.

The term “Credit Card Issuer,” as used hereinbelow, may be a global company, e.g., a credit union, that is configured to issue Credit Cards or payment cards or provide others, e.g., banks or other credit unions or other businesses, the right to issue Credit Cards and extend credit to their customers (“Issuer.”)

The term “a payment service provider (PSP)” as used hereinbelow, may be a global company, e.g., a credit union, that is configured to issue Credit Cards or payment cards and/or other payment means and to pay for purchases made with the issued card.

The term “Credit Card Scheme,” as used hereinbelow, may include payment networks linked to credit cards and/or debit cards and/or prepaid cards or the like, e.g., payment cards, of which a bank and/or any other eligible financial institution and/or credit can be members. For example, members of the credit card scheme may issue cards and/or merchants operating on the network of that card scheme. The members can also set the various rules and limits of their schemes.

The term “Issuer Platform,” as used hereinbelow, may include, for example, the Mastercard, Visa, EuroPay, American Express, etc., servers, which may be configured to allow for the issuing of cards.

The term “Card/s,” as used hereinbelow, may include, for example, the prepaid card created and issued by an issuer, credit cards, debit cards or the like.

The term “Merchant POS,” as used hereinbelow, may include, for example, the credit card terminal of a specific merchant and/or vendor and/or shop and/or etc., on which various payment transactions can be made when an End-User decides to consume a payment transaction using his Customer Mobile application.

The term “Customer Platform,” as used hereinbelow, may include, for example, the technology platform of a customer of a partner which is configured to engage with the digital wallet for the provision of payments through the digital wallet platform. The backend technology platform communicates with the Customer Mobile Application as well as with the digital wallet SDK, depending on the payment configuration chosen by the customer and/or partner. For example, this platform will be cloud-based, running on, for example, Amazon Web Services (AWS) and/or Microsoft AZURE.

The term “Customer Credit Card Terminal,” as used hereinbelow, may include a transaction terminal, EMV and/or non-EMV, which may be used by the Customer platform to generate a payment element for each End-User credit card associated with the customer mobile application. For example, such terminals may reside with a payments gateway company or processor company

The term “customer mobile application,” as used hereinbelow, may include at least one application which is installed on the customer mobile device, for example, the loyalty club application, e-Wallet application, or the like. The customer mobile application may include the digital wallet SDK and may interact with the digital wallet platform and the customer platform. The customer mobile application may be configured to run on a mobile device operating system, such as, for example, iOS and Android or React.

The term “customer CRM,” as used hereinbelow, may include, for example, the loyalty club platform that the customer uses to manage his customers base and his reward schemes and such other programs across various segments and plans.

The term “digital wallet rules engine,” as used hereinbelow, may include, for example, an admin system where the customer can define various rules, including Merchant Category Code (MCC), wherein the MCC includes universal codes on the card scheme that define the various purchase/merchants categories, such as, for example, clothing, sports shoes, etc. codes, and limitations, etc., for transactions made by the end-users.

The term “End-User,” as used hereinbelow, may include one or more users who use the customer mobile application.

The term “Payment element,” as used hereinbelow, may include a unique placeholder called a payment element which is configured to include encrypted information of a payment ability of the user, for example, a credit card, a debit card, a prepaid card, a reloadable prepaid card, bank money transfer information, or the like. For example, if a card number is 1234 5678 8765 4321, the payment element identification may be, for example, E67TL8GC27X. In some demonstrative embodiment, the payment element may be configured to access, retrieve, and maintain, for example, a customer's credit card information to ensure a higher level of security for both the customer and the business. The payment element may be saved on the customer platform and/or on the customer's mobile application. For example, a disposable payment element as used hereinbelow is a payment element which is deleted after a one-time use.

The term “Payment element Service Provider (PESP),” as used hereinbelow, is an entity certified by, for example, MasterCard, Visa, or any other issuers, which are allowed to generate EMV payment elements. The PESP may include an entity within the payments ecosystem that is configured to provide registered payment element requestors. For example, the merchants holding the card credentials—with ‘surrogate’ Primary Account Number (PAN) values, otherwise known as payment elements. For example, the service may be provided by gateway services if desired.

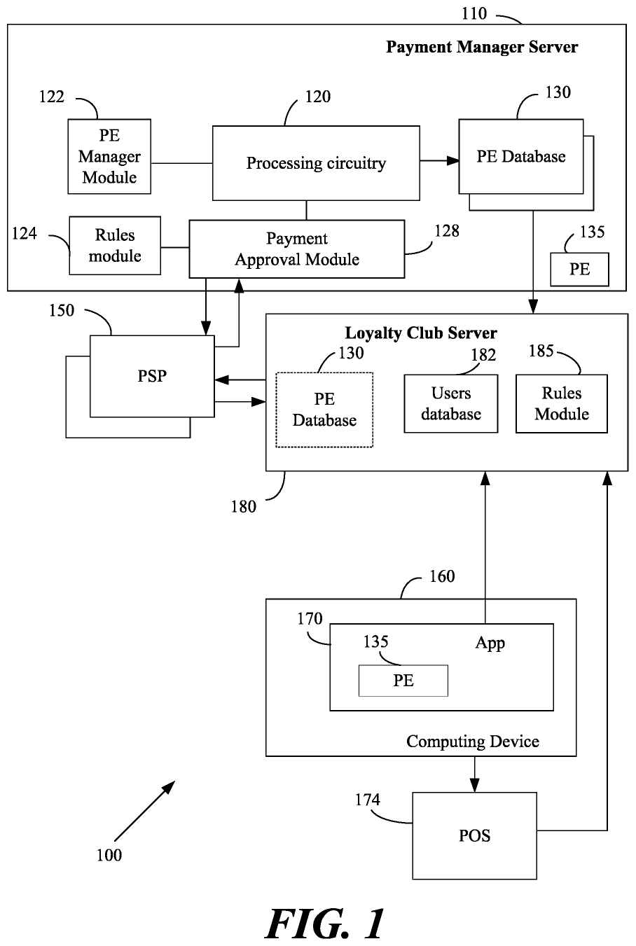

Reference is made first to FIG. 1, which is an illustration of a block diagram of a system 100 for executing payments over a network 190 according to some demonstrative embodiments.

In some demonstrative embodiments, system 100 may include a payment manager server 110 configured to manage purchasing done over the network by clients of a business group. For example, the clients that may be members of a club, e.g., loyalty club. For example, the business group may establish the club to provide one or more benefits to its members for an activity, e.g., purchasing goods and/or services they have done at the business group facilities.

In some demonstrative embodiments, system 100 may include a processing circuitry 120. For example, the processing circuitry 120 may run one or more software instructions provided by at least one of a payment element manager module 122, a rules module 124, and a payment approval module 128.

For example, processing circuitry 120 may include circuits, logic, memory, operating system, one or more cores computer, a graphic processor, a digital signal processor, or the like.

Although, it should be understood that in some other embodiments, each of the payment element manager module 122, the rules module 124, and the payment approval module 128 may be implemented by software and/or by hardware and/or by a combination of software and hardware.

In some demonstrative embodiments, processing circuitry 120 may be configured to receive a request from a payment service provider (PSP) 150 to approve an amount paid with a disposable payment element 135 at a point of sale (POS) 174. For example, the PSP 150 may include a disposable payment element issuer (not shown). The disposable payment element issuer and may be configured to issue the disposable payment elements and to transfer payments to a merchant.

In some demonstrative embodiments, processing circuitry 120 may be configured to receive a message from the PSP 150 that a purchase made at the POS 144 is completed. The processing circuitry 120 may delete the disposable payment element 135 from the database 130, may generate a new disposable payment element, and may upload the new disposable payment element, e.g., payment element 135, to the database 130.

For example, the approval of the amount of the purchasing may be done by the payment approval module 128, and the deletion of an old disposable payment element 135, the generation and the uploading of the new disposable payment element may be done based on the instructions from the payment elements manager module 122, if desired.

In some demonstrative embodiments, processing circuitry 120 may be configured to approve purchasing done by the disposable payment element 135 by examining the purchasing details against one or more sets of rules. For example, the examination may be done by the rules module 124, if desired.

For example, the one or more sets of rules may include the business group of members set of rules and/or a payment card issuer set of rules and/or combination of the business group of members set of rules with the payment card issuer set of rules. The set of rules may include, for example, how and where to spend the credits, for example, the loyalty club points. The set of rules may include an exchange rate of loyalty club point to currency and other rules.

In some demonstrative embodiments, processing circuitry 120 may be configured to transfer an amount of money paid by the PSP 150 for purchases made by members of the business group of members to the PSP 150 at a predetermined date to the PSP 150.

In some demonstrative embodiments, the payment elements manager module 122 may be operably coupled to the database 130 at the payment manager server 110. The payment elements manager module 122 may be configured to allocate the disposable payment element 135 to a member of the loyalty club at the loyalty club server 180.

In some demonstrative embodiments, processing the POS 174 may allow purchasing by the business group member, e.g., loyalty club member, according to a purchasing agreement with the PSP 150. For example, the purchasing agreement may include the name of the goods, the price of the goods, number of payments, warranty terms, a discount, terms of return the goods and etc.

In some demonstrative embodiments, the database 130 may be allocated within the payment manager server 110 and may be operably coupled to the loyalty club server 180.

In some demonstrative embodiments, database 130 may be allocated within the loyalty club server 180 and may be operably coupled to the payment elements manager module 122 at the payment elements (PE) manager server 110.

In some demonstrative embodiments, users database 182 at loyalty club server 180 may include one or more members of a loyalty club or one or more members of a rewarding club, and etc.

In some demonstrative embodiments, system 100 may include a computing device 160. For example, the computing device 160 may include a purchasing application 170 for providing the member of a group of members the ability to purchase services and goods over the network and/or stores.

For example, the computing device 160 may include a desktop computer, a laptop computer, a tablet, a cellphone, a purchasing terminal, a game consulate, or the like.

For example, purchasing application 170 may include a group of members application, e.g., loyalty club application, which may be configured to store details of disposable payment element 135. In some demonstrative embodiments, purchasing goods and/or services with a purchasing application 170 by members of the group of members, e.g., loyalty club members. For example, the purchasing application 170 may be provided by the business group, .g., loyalty club, to their members.

In some demonstrative embodiments, the purchasing application 170 may be configured to convert a coupon and/or a reward and/or a right of the business group of members and/or other benefits to an amount of money. For example, this amount of money may be used to pay at POS 174 based on the data stored at the disposable payment element 135.

In some demonstrative embodiments, the disposable payment element 135 may include, for example, data of a disposable virtual payment card having a disposable identification code. For example, when the disposable payment element 135 includes a credit card, it may include at least one of a credit card number, a credit card issue date, and a credit card security code.

For example, when the disposable payment element 135 includes a prepaid card. The prepaid card may include at least one of a prepaid card number, a prepaid card issue date, and a prepaid card security code.

For example, when the disposable payment element 135 includes a loadable card, it may include at least one of: a loadable card number, a loadable card issue date, and a loadable card security code.

For example, when the disposable payment element 135 includes a debit card, the disposable payment element 135 may include at least one of a debit card number, a debit card issue date, and a debit card security code.

In some demonstrative embodiments, a content of the disposable payment element 135 may be encrypted, and the POS 174 may be configured to decrypt the content of the disposable payment element 135

In some demonstrative embodiments, the POS 174 may include an at least one of cashier machine, a physical payment terminal, and a virtual payment terminal. The POS 174 may be configured to transfer the decrypted content of the payment element to PSP 150.

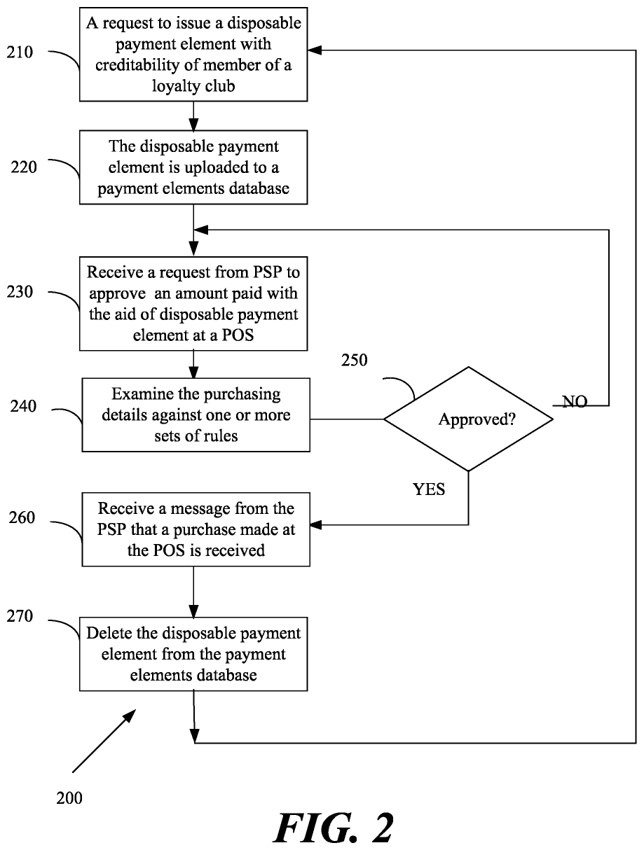

Reference is now made to FIG. 2, which is a schematic illustration of a flow chart of a method for purchasing goods over a network, according to some demonstrative embodiments.

In some demonstrative embodiments, method 200 may start with a request to issue a disposable payment element, e.g., payment element 135 (FIG. 1) with the creditability of a member of a group of members, e.g., a loyalty club member (text box 210). For example, the request may be sent to PSP 150 (FIG. 1).

In some demonstrative embodiments, a PSP 150 (FIG. 1) may issue a disposable payment element. The disposable payment element may include a disposable virtual credit card and/or debit card and/or a loadable card and/or any other card. It should be understood that the disposable payment element may be issued without any balance, for example, a zero balance.

In some demonstrative embodiments, the disposable payment element may be uploaded to a payment elements database, e.g., 130 (FIG. 1), (text box 220).

In some demonstrative embodiment, when the member of the group, e.g., loyalty club member, performs a purchase from an application, e.g., App 170 (FIG. 1), a request for approval of the payment may be sent by the PSP, e.g., PSP 150 (FIG. 1) to a payment manager server, e.g., payment manager server 110 (FIG. 1) (text box 230).

In some demonstrative embodiment, a payment approval module 128 of payment manager server 110 (FIG. 1) may examine the purchasing details against one or more sets of rules (text box 240). For example, a loyalty club rules and/or a PSP set of rules, e.g., payment card issuer set of rules.

In some demonstrative embodiments, when the approval for the payment has been received at the POS, e.g., POS 174 (FIG. 1) (text box 260), the disposal payment element, e.g., disposal payment element 135 (FIG. 1), may be deleted, for example, by the payment element manager module 122 FIG. 1, from the database, e.g., database 130 (FIG. 1) (text box 270).

In some demonstrative embodiment, method 200 may be repeated for the next purchase and/or for each and every purchase.

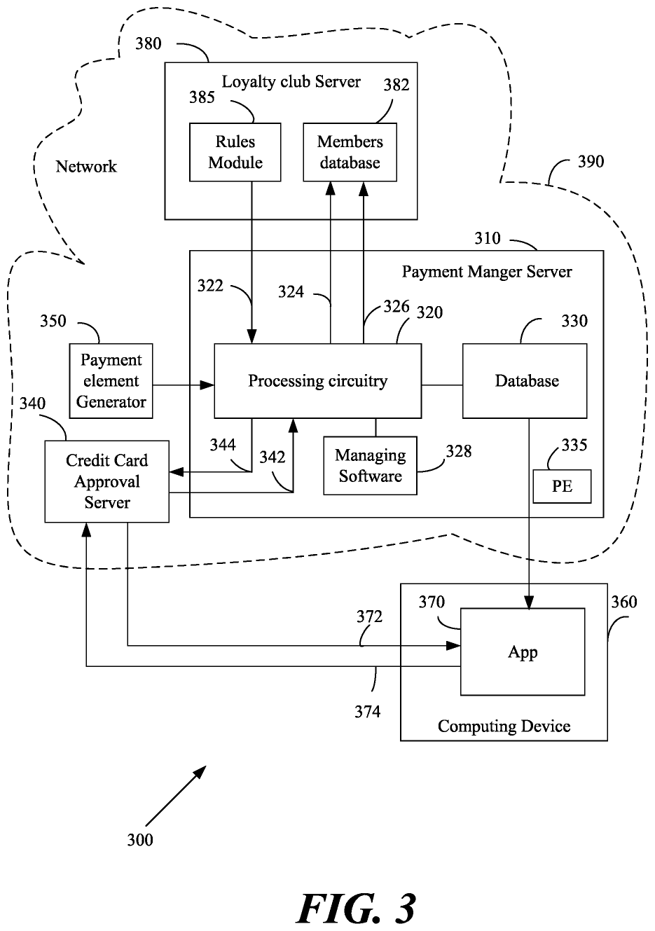

Reference is made to FIG. 3, which is an illustration of a block diagram of a system 300 for executing payments over a network 390 according to some other demonstrative embodiments.

In some demonstrative embodiments, system 300 may include a payment manager server 310 configured to manage a process of payment over the network 390 by providing a disposable payment element 335. For example, the disposable payment element 335 may be used to pay for goods and/or services over the network 390 and at stores, if desired.

In some demonstrative embodiments, system 300 may include a credit card approval server 340. For example, the credit card approval server 340 may be configured to approve payments made by the disposable payment element 335.

In some demonstrative embodiments, system 300 may include a payment element generator 350, e.g., issuer server. For example, payment element generator 350 may be configured to issue the disposable payment element 335 for a member of a loyalty club, if desired.

In some demonstrative embodiments, the disposable payment element 335 may include a credit card number, e.g., the member credit card number, a credit card date of issues, and a credit card security code.

In some demonstrative embodiments, system 300 may include a computing device 360. For example, the computing device 360 may include a business group club application (App) 170, e.g., a loyalty club application, to allow a business club member to purchase services and goods over the network 390 and/or at stores.

For example, the computing device 360 may include a desktop computer, a laptop computer, a tablet, a cellphone, a purchasing terminal, a game consulate, or the like.

In some demonstrative embodiments, system 300 may include a group server 380, for example, a loyalty club server. For example, the group server 380 may include a members database 382 and rules module 385. Group server 380 may be configured to manage accounts, profiles, coupons, rewards, and other benefits of, for example, loyalty club members and/or any other groups which include members.

In some demonstrative embodiments, the members database 382 may include details about the group members, e.g., loyalty club members. For example, the details of a group member may include a group member Identification Number (ID), a personal ID, address, coupons, credits, email address, telephone number, credit card details, bank account details, etc. The rules module 385 may include a set of rules for each group member, e.g., the loyalty club member.

In some demonstrative embodiments, server 310, e.g., a payment manager server, may include a managing software 328, which may be configured to run on processing circuitry 320. For example, processing circuitry 320 may include circuits, logic, memory, operating system, one or more cores computer, a graphic processor, a digital signal processor, or the like.

In some demonstrative embodiments, payment manager server 310 may include a database 330 for storing, at least in part, a plurality of payment elements of the loyalty club members. For example, database 330 may include a members database that includes at least one group of members and a payment elements database that includes one or more disposable payment elements. For example, a payment element 335 from the database 330 may be allocated to a member of the group of members. For example, the group may include one or more loyalty club members.

In some demonstrative embodiments, the processing circuitry 320 may be configured to receive a request to provide the payment element 335 with the member details to perform a purchase from purchasing application 370 at a point of sale (POS) (not shown). For example, the POS may send a request to check the member credit balance to the group server, convert the member one or more club credits to money, upload the money to the disposable payment element, receive a message that the purchase is completed and delete the payment element 335 from database 330, and upload a new disposable payment element to database 330.

In some demonstrative embodiments, the content of the payment element 335 can be encrypted, and payment manager server 310 may be configured to decrypt the content of payment element 335. For example, payment element 335 may include data of a disposable virtual payment card having a disposable identification code.

For example, payment element 335 may include a debit card number and/or credit card number, a debit card date of issues and/or a credit card date of issue and/or a debit card security code and/or credit card date of issue.

It should be understood that payment element 335 may include any type of payment card, for example, a user loyalty club card.

In some demonstrative embodiments, a user loyalty club card may include the creditability information of the member.

In some demonstrative embodiments, disposable payment element 335 may be deleted after the payment, and a new disposable payment element may be issued by payment element generator 350, e.g., issuer server. The new payment element may include the user creditability information which may be used on the next purchase and a zero balance.

In some demonstrative embodiments, when a business group member, e.g., a loyalty club member, purchases goods and/or services by purchasing application 370 over a network 390, the disposable payment element 335 having a zero balance, may be uploaded with a requested amount of money from database 330 to App 370. For example, App 370 may send a request (line 374) to the credit card approval server 340 to approve the purchases and upload the requested money to the disposable payment element 335.

In some demonstrative embodiments, the credit card approval server 340 may send a request (line 342) to check the user balance and/or creditability to processing circuitry 320. For example, the request may include the member ID and/or the member membership number and/or any other user identification.

In some demonstrative embodiments, processing circuitry 320 may forward the request to group server 380. Group server 380 may check if the member is a member at the user database 382 based on, for example, the member ID. If the user is a member of the group of members, the group server 380 may send a set of rules applicable for this member from the rules database 385 to processing circuitry 320 (line 322).

In some demonstrative embodiments, the credit card approval server 340 may approve and/or deny the request for money transaction based on the rules. If the request is approved, the credit card server 340 may upload the requested sum of money to the disposable payment element, e.g., payment element 335. App 370 may update credit card server 340 that the transaction is completed. The credit card server 340 may update the managing software 328 that the payment element has been used. The processing circuitry 320 may instruct the group server 380 to update the member account, e.g., member creditability (line 326).

In some demonstration embodiments, the processing circuitry 320 may instruct the payment element generator 350 to generate a new disposable payment element and to upload the new disposable payment element to database 330.

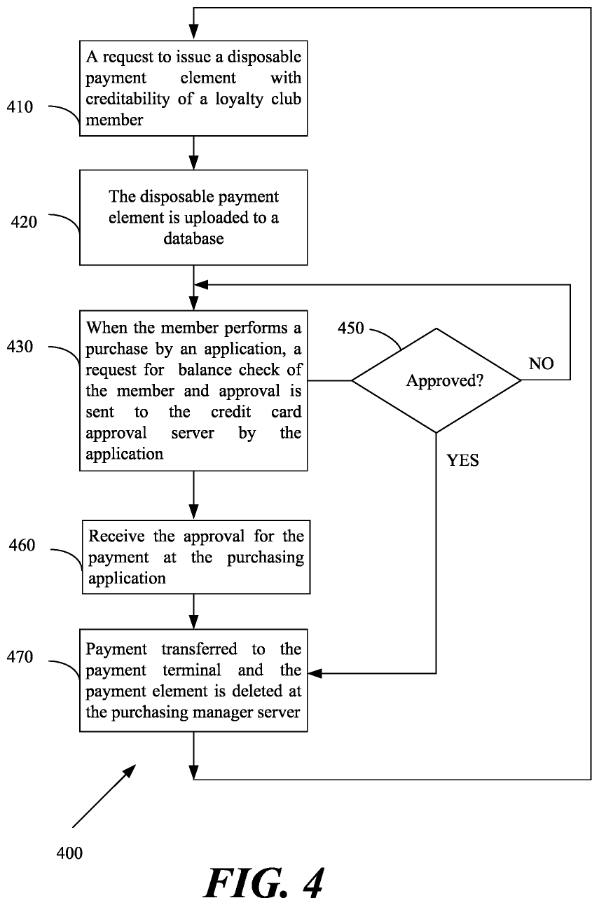

Reference is now made to FIG. 4, which is a schematic illustration of a flow chart of a method 400 for purchasing goods using over a network, according to some other demonstrative embodiments.

In some demonstrative embodiments, method 400 may start with a request to issue a disposable payment element, e.g., payment element 335 (FIG. 3) with the creditability of a business club member from a goods purchasing application and/or services purchasing application, e.g., App 370 (FIG. 3) (text box 310).

For example, the request may be sent to a credit card approval server, e.g., credit card approval server 340 (FIG. 3).

In some demonstrative embodiments, a payment element generator 350 (FIG. 3) may be configured to issue the disposable payment element, and/or a disposable virtual credit card and/or disposable debit card and/or a disposable reloaded card and/or any other disposable cards related to the member creditability. It should be understood that the disposable virtual payment card may be issued without any balance, for example, a zero balance.

For example, the disposable virtual payment element may include a credit card, a debit card, a charge card, a prepaid card, a loadable card, or the like.

In some demonstrative embodiments, the disposable payment element may be uploaded to the loyalty club application, e.g., application 370 (FIG. 3), (text box 420).

In some demonstrative embodiment, when the member performs a purchase from the loyalty club application, e.g., App 370 (FIG. 3) and a request for a balance check of the member and approval of the payment may be sent to the credit card approval server, e.g., credit card approval server 340 (FIG. 3) (text box 430).

For example, credit card approval server 340 (FIG. 3) may receive a request to check the bank account balance of the loyalty club member from the application. The request may be sent from the credit card approval server 340 (FIG. 3) to the group server 380 (FIG. 3), e.g., the loyalty club server.

In some demonstrative embodiments, server 380 (FIG. 3), e.g., loyalty club server, may be configured to send a balance and/or a credit of a group member and a set of rules of how and where to spend the credits, for example, the loyalty club points. The set of rules may include an exchange rate of loyalty club point to currency and other rules.

For example, credit card approval server 340 may approve or deny the request for payment. If the credit card approval server 340 approves the payment (text box 450), the credit card approval server 340 may convert the club points to money and upload a requested amount of money to the disposable payment element, e.g., disposable payment element 335 (FIG. 3).

In some demonstrative embodiments, when the approval for the payment has been received at the purchasing application, e.g., App 370 (text box 460), the application may collect the payment, and the credit card approval server 340 may, for example, delete the disposable payment element, e.g., disposable virtual payment card, and the purchasing manager server 310 may delete the disposable payment element (text box 470).

In some demonstrative embodiment, method 400 may be repeated for the next purchase and/or for each purchase done by members of the group.

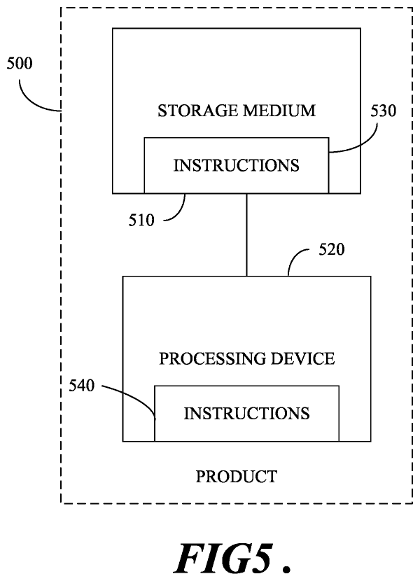

Reference is now made to FIG. 5, which is a schematic illustration of a product of manufacture 500, according to some demonstrative embodiments. Product 500 may include one or more tangible computer-readable non-transitory storage media 510, which may include computer-executable instructions 530, implemented by processing device 520, operable to, when executed by at least one computer processor, enable the at least one processing circuitry 120 (FIG. 1) to implement one or more program instructions for purchasing goods and/or services over the network by an application, e.g., App 170 (FIG. 1) and/or to perform, trigger and/or implement one or more operations, communications and/or functionalities as described above with reference to FIGS. 1-4. The phrase “non-transitory machine-readable medium” is directed to include all computer-readable media, with the sole exception being a transitory propagating signal.

In some demonstrative embodiments, product 500 and/or machine-readable storage medium 510 may include one or more types of computer-readable storage media capable of storing data, including volatile memory, non-volatile memory, removable or non-removable memory, erasable or non-erasable memory, writeable or re-writeable memory, and the like. For example, machine-readable storage medium 510 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusen drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, processing device 520 may include logic. The logic may include instructions, data, and/or code, which, if executed by a machine, may cause the machine to perform a method, process and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 520 may include or may be implemented as software, firmware, a software module, an application, a program, a subroutine, instructions, an instruction set, computing code, words, values, symbols, and the like. Instructions 540 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled and/or interpreted programming languages, such as C, C++, C#, Java, Python, BASIC, Mat lab, assembly language, machine code, and the like.

It is to be understood that the system and/or the method for performing purchases over a network using a disposable payment element is described hereinabove by way of example only. Other embodiments may be implemented base on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware, and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that, when executed, perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts, or combinations of specialized purpose hardware and computer instructions.

The terminology used herein is to describe particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein are for the purpose of description and should not be regarded as limiting. The use of “including,” “comprising,” or “having,” “containing,” “involving,” and variations thereof herein is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

What is claimed is:

1. A system for executing payments over a digital network comprising:
a first server comprises processing circuitry, wherein the first server is operably coupled to a second server comprises a database which comprises a plurality of payment elements of a plurality of loyalty club members, the processing circuitry is configured to:
allocate a disposable payment element to a member of the loyalty club from the plurality of payment elements;
receive a request message from a payment service provider (PSP) to approve a paid amount which paid with an aid of the disposable payment element at a point of sale (POS);
send an approval message to approve the paid amount;
receive a confirmation message from the PSP that a payment made at the POS is received;
delete the disposable payment element from the plurality of payment elements after receiving the confirmation message; and
upload a new disposable payment element to the plurality of payment elements at the database.

2. The system of claim 1, wherein the processing circuitry is configured to approve the payment by examining payment details against one or more sets of rules, wherein the set of rules comprises an exchange rate of a benefit of the member of the loyalty club to a currency.

3. The system of claim 2, wherein the one or more sets of rules comprises a loyalty club set of rules and the loyalty club set of rules comprises an exchange rate of a loyalty club benefit to currency.

4. The system of claim 2, wherein the one or more sets of rules comprises a payment card issuer set of rules, wherein a PSP set of rules comprises a value check of the benefit against the payment.

5. The system of claim 4, wherein the processing circuitry is configured to transfer an amount of money paid by the first server for purchases made by members of the loyalty club to the PSP at a predetermined date.

6. The system of claim 4, wherein the POS enables purchasing of the loyalty club member according to a purchasing agreement with the PSP, wherein the purchasing agreement comprises one or more purchase terms.

7. The system of claim 1, wherein the database is allocated within the second server and operably coupled to the first server.

8. The system of claim 1, wherein the database is allocated within the first server and operably coupled to the second server.

9. The system of claim 1, wherein a purchasing application is configured to convert a coupon of the loyalty club to an amount of money is used to pay at the POS by using the disposable payment element.

10. The system of claim 1, wherein a purchasing application is configured to convert a reward of the loyalty club to an amount of money is used to pay at the POS by using the disposable payment element.

11. The system of claim 1, wherein a purchasing application is configured to convert a benefit of loyalty club to an amount of money is used to pay at the POS by using the disposable payment element.

12. The system of claim 1, wherein the disposable payment element comprises data of a disposable virtual payment card having a disposable identification code.

13. The system of claim 1, wherein a content of the payment element is encrypted and the POS is configured to decrypt the content of the payment element, wherein the POS comprises an at least one of a cashier machine, a physical payment terminal and a virtual payment terminal.

14. The system of claim 1, wherein a content of the payment element is encrypted and the POS is configured to transfer the decrypted content of the payment element to PSP, wherein the POS comprises an at least one of a cashier machine, a physical payment terminal and a virtual payment terminal.

15. The system of claim 1, wherein the payment element comprises at least one of a debit card number, a debit card issue date and a debit card security code.

16. The system of claim 1, wherein the payment element comprises at least one of a credit card number, a credit card issue date and a credit card security code.

17. The system of claim 1, wherein the payment element comprises at least one of a prepaid card number, a prepaid card issue date and a prepaid card security code.

18. The system of claim 1, wherein the payment element comprises at least one of a loadable card number, a loadable card issue date and a loadable card security code.

19. The system of claim 1, wherein the first server comprises a payment manager server.

20. The system of claim 1, wherein the second server comprises a loyalty club server.

21. A product comprising one or more tangible computer-readable non-transitory storage media comprising program instructions for making payments with a payment manager program, wherein execution of the program instructions of the payment manager program by processing circuitry results in:
receiving a request from a payment service provider (PSP) to approve an amount paid with an aid of the disposable payment element at a point of sale (POS);
sending an approved message to approve the paid amount;
receiving a confirmation message from the PSP that a purchase made at the POS is received;
deleting the disposable payment element from the plurality of payment elements at the database; and
uploading a new disposable payment element to the plurality of payment elements at the database.

22. The product of claim 21, wherein execution of the program instructions by the processing circuitry results in approving the purchase by examining the purchase details against one or more sets of rules.

23. The product of claim 22, wherein the one or more sets of rules comprises a loyalty club set of rules.

24. The product of claim 22, wherein the one or more sets of rules comprises a PSP set of rules.

25. The product of claim 24, wherein execution of the program instructions by the processing circuitry results in transferring an amount of money paid by the payment manager server for purchases made by members of the business group of members to the PSP at a predetermined date.

26. The product of claim 24, wherein the POS is configured to enable purchasing of the loyalty club member according to a purchasing agreement with the PSP, wherein the purchasing agreement comprises one or more purchase terms.

27. The product of claim 21, wherein a purchasing application is configured to convert a coupon of the loyalty club to an amount of money is used to pay at the POS by using the disposable payment element.

28. The product of claim 21, wherein a purchasing application is configured to convert a reward of the loyalty club to an amount of money is used to pay at the POS by using the disposable payment element.

29. The product of claim 21, wherein a purchasing application is configured to convert a benefit of the loyalty club to an amount of money is used to pay at the POS by using the disposable payment element.

30. The product of claim 21, wherein the disposable payment element comprises data of a disposable virtual payment card having a disposable identification code.

31. The product of claim 21, wherein a content of the payment element is encrypted and the POS is configured to decrypt the content of the payment element, wherein the POS comprises an at least one of a cashier machine, a physical payment terminal and a virtual payment terminal.

32. The product of claim 21, wherein a content of the payment element is encrypted and the POS is configured to transfer the decrypted content of the payment element to PSP, wherein the POS comprises an at least one of a cashier machine, a physical payment terminal and a virtual payment terminal.

33. The product of claim 21, wherein the payment element comprises at least one of a debit card number, a debit card issue date and a debit card security code.

34. The product of claim 21, wherein the payment element comprises at least one of a credit card number, a credit card issue date and a credit card security code.

35. The product of claim 21, wherein the payment element comprises at least one of a prepaid card number, a prepaid card issue date and a prepaid card security code.

36. The product of claim 21, wherein the payment element comprises at least one of a loadable card number, a loadable card issue date and a loadable card security code.

37. A system for executing payments over a digital network comprising:
a server comprises:
a users database that includes at least one group of members;
a payment element database that includes one or more disposable payment elements and configured to allocate a disposable payment element to a member of the group of members; and
processing circuitry configured to:
receive a request to provide the disposable payment element with the member details to perform a purchase from a point of sale (POS);
send a request to check the member credit balance to the group server;
convert the member credit to money and upload the money to the disposable payment element;
receive a message that the purchase is completed and delete the disposable payment element from the database, and upload a new disposable payment element to the database.

38. The system of claim 37, wherein the server is configured to manage a payment process by allocating a disposable payment element for a member of the group for paying over the network.
